(19) United States
(12) Patent Application Publication
(10) Pub. No.: US 2017/0144032 A1
(43) Pub. Date: May 25, 2017

(54) A TYPE OF GLOW BALL

(71) Applicant: BEIJING WENHAIYANG INDUSTRY & TRADING CO., LTD., Beijing (CN)

(72) Inventor: Zhaoyang JIN, Beijing (CN)

(21) Appl. No.: 15/325,707

(22) PCT Filed: Jul. 10, 2015
(86) PCT No.: PCT/CN2015/000496

§ 371 Date: Jan. 11, 2017

(30) Foreign Application Priority Data
Jul. 11, 2014 (CN) 201420384764.0

(51) Int. Cl. A63B 43/06; F21K 2/06; A63B 39/00

(52) U.S. Cl. CPC A63B 43/06; A63B 39/00; F21K 2/06

(57) ABSTRACT

A kind of glow ball comprises a ball shell made of flexible and transparent material, and an empty cavity is formed in the said ball shell. The said empty cavity contains chemiluminescent reagents (2-A, 2-B), and the said chemiluminescent reagents solid or liquid or solid-liquid mixture, and the said chemiluminescent reagents are two kinds of reagent sealed separately and can generate chemiluminescent reaction when they are combined. At least one kind chemiluminescent reagent is contained in one or more breakable containers. The application adopts that the inner wall of the ball shell is with protrusions or polyhedral or many pits or grooves and/or protrusive ribs and is placed with dispersed particles, such as scraps of paper, plastic film, or small plastic particles, etc.

### TECHNICAL FIELD

This invention is related to a type of glow ball.

### DESCRIPTION OF THE RELATED ART

The chemiluminescent device has always been stick shaped generally, from which glow bracelets, glow eyeglasses were derived. Due to the specialty in the shape of ball structure, it is difficult to obtain the chemiluminescent light, the true sense of glow ball has not been being. The present invention provides a kind of ball-shaped chemiluminescent device and filles the gap. From the point of internal chemical reaction mechanism, the civilian-used chemiluminescent light is generated from the chemical reaction by mixing chemiluminescent chemicals, such as substituted-phenyl Bis oxalate, fluorescent, oxidizer, solvent etc. Generally, the ingredients that contain substituted-phenyl Bis oxalate are called component of chemiluminescent reagents, while the ingredients that contain peroxide are known as the component of oxidizer, both of which are called chemiluminescent chemicals. In different condition, the glowing effect of ingredients with high viscosity or solid could be achieved by using different solvents or dispersants, even not using the solvents. Currently, the Bis(2,4,5-trichloro-6-carbopentoxyphenyl)oxalate (CPPO) or Bis(2,4,5-trichloro-6-i-pentoxycarbonylphenyl)oxalate (CIPO) is most widely used as substituted-phenyl Bis oxalate, which is normally kept separately from the component of oxidizer before using; While using, the isolation between them will be broken to make them mix and glow.

### DETAILS OF THE INVENTION

According to the above said problem, this invention aims to provide a type of glow ball, which is bouncing ball, and its internal chemical luminescence system can glow based on the requirements of people.

To accomplish the objectives mentioned above, this invention takes the following technical solution: a kind of glow ball, which consists of a ball shell made of flexible and transparent material, an empty cavity is in the said ball shell, and the glow ball is characterized in that the said empty cavity contains chemiluminescent reagents, the said chemiluminescent reagents are solid or liquid or solid-liquid mixture, and the said chemiluminescent reagents are two kinds of reagent sealed separately and can generate chemiluminescent reaction when they are combined. At least one kind of chemiluminescent reagent is contained in one or more breakable containers.

The said glow ball according to the above Claims, it is characterized in that, the said breakable container is sealed glass container or film capsule.

The said glow ball according to the above Claims, it is characterized in that, the activating device of the breakable container is set inside the said empty cavity.

The said glow ball according to the above Claims, it is characterized in that, the activating device is a bracket capable of supporting and/or fixing a breakable container.

The said glow ball according to the above Claims, it is characterized in that, the said brackets include fixing device, a rod connected with the fixing device, one end of the said rod points to the said breakable container, the other end points to the said ball shell inner wall and near or in contact with the said ball shell inner wall, the said fixing device stuck the said breakable containers.

The glow ball according to above claims, it is characterized in that, a hole and a sealing plug matched with the said hole are equipped on the said ball shell. A tube is placed from the hole to the empty cavity of the ball shell. A blocking device is set at one end of the tube in the inner empty cavity of the said ball. Leaks are set on the said blocking device. A rod is set in one side of the sealing plug in the ball shell. The end of the rod is provided with a piston which is matched with the inner wall of the tube for movement. The said breakable containers are between the said piston and the said blocking device.

To achieve the object of this invention, a technical scheme is taken, a glow ball comprises a ball shell made of transparent material, and there is an empty cavity inside the ball shell. It is characterized that the said ball shell contains the hole, a sealing plug is set on the said hole, and the chemiluminescence reagents are sealed in the said empty cavity.

The glow ball according to the above claims, it is characterized in that, the sealed inflatable capsule is equipped inside the said ball shell. And the said chemiluminescent reagents are sealed in the said inflatable capsule or the areas between the said inflatable capsule and the inner wall of the said ball shell.

The glow ball according to above claims, it is characterized in that, the said ball shell contains the hole, the sealing plug is set on the said hole, the sealed inflatable capsule is equipped inside the said ball shell, the chemiluminescent reagents are placed inside the inflatable capsule, the said chemiluminescent reagents are two kinds of reagent sealed separately and can generate chemiluminescent reaction when they are combined. At least one kind chemiluminescent reagent is contained in one or more breakable film capsules.

The glow ball according to above claims, it is characterized in that, the appearance of the said ball shell is spheroidal or elliptical or oval or polyhedral, meanwhile its inner surface is polyhedral or with many pits or/and protrusions, or with grooves or/and protrusive ribs.

The present invention has the following advantages over adopting the above technical scheme:

The invention adopts the above technical scheme, truly realizes the glow ball contains the glowing liquid inside, fully shows the special effect of liquids glowing, especially the glowing effect of the ball rotating and bouncing, comparing with existing electroluminescence pure flashing etc., are very different, greatly increase the ball entertaining.

The invention adopts many conical protrusions on the inner wall of the ball shell, which can greatly reduce the possibility of the TPU shell puncture and leakage when the glass is broken and after the activation of the ball. It is because the protrusive parts hold the broken glass fragments and control its sharp cutting edge avoid forming enough impact force to puncture the ball wall.

The invention adopts that the inner wall of the ball shell is with protrusions or polyhedral or many pits or grooves or/and protrusive ribs and is placed with dispersed particles, such as scraps of paper, plastic film, or small plastic particles . . . Not only do give people a sense of uniform dispersion effect, also a certain visual shielding effect to the breakable containers and broken pieces to reduce users' discomfort perception of, for example, the glass fragments.

### DESCRIPTION OF THE DRAWINGS

FIG. 1 is the Cross-sectional view of the invention.

FIG. 2 is the three-dimensional cross-sectional view of the glow ball that contains two breakable containers provided in this invention.

FIG. 3 is the cross-sectional view of the glow ball shown in FIG. 2.

FIG. 4 is the cross-sectional view of the glow ball containing the support rod typed activating device of this invention.

FIG. 5 is the three-dimensional cross-sectional view of the glow ball containing two breakable containers and support rod typed activating device of this invention.

FIG. 6 is the cross-sectional view of the glow ball containing support bracket typed activating device of this invention.

FIG. 7 is the top view of FIG. 6.

FIG. 8 is the structural drawing of the glow ball containing sealed plug of this invention.

FIG. 9 is the structural drawing of the glow ball containing inflatable inner capsule and sealed plug of this invention.

FIG. 10 is the structural drawing of the glow ball containing inflatable inner capsule that filled with chemiluminescent liquids of this invention.

FIG. 11 is the structural section view of the glow ball shell containing with the tube of this invention.

FIG. 12 is the activating device usage view of the said glow ball shown in FIG. 11.

FIG. 13 is the section view of the glow ball containing the protrusions on its shell inner surface of this invention.

### THE BEST EMBODIMENT OF THE INVENTION

Detailed representations combining with attached figures and implementations towards the present invention are as follows.

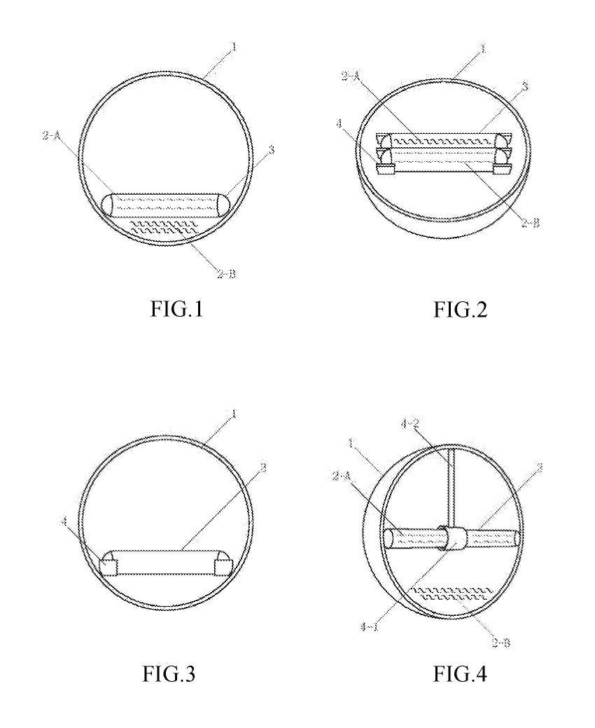

As shown in FIG. 1, the invention provides a kind of glow ball, which comprises a ball shell 1, which is made of 1.5 mm-thick, flexible and transparent material- polyethylene (PE). The diameter of the ball shell 1 is 65 mm. 1.5 ml of chemiluminescent reagent (2-B) are placed inside the ball shell 1. The chemiluminescent reagent (2-B) is oxidizing solution containing hydrogen peroxide. The breakable container 3 placed in the ball shell 1 is a glass ampoule with two ends sealed. The wall thickness of the said glass ampoule is 0.3 mm, the length is 50 mm, and the diameter is 9 mm. The glass ampoule is sealed with 1.6 grams of chemiluminescent reagent (2-A), which is luminescence reagents component consisting of Bis Oxalate and fluorescent agent, they can be mixed component of solids or liquids that can be dissolved in solvent. When use, throw the ball to the ground or wall to have the inside glass ampoule broken to make the chemiluminescent reagent (2-A) release. Visible light can be released when the chemiluminescent reagent (2-A) and chemiluminescent reagent (2-B) are mixed to generate Chemiluminescent reaction. The inner surface of the ball shell 1 is covered with glowing liquid caused from bouncing and rolling of the glowing ball. It looks very beautiful. Shattered glass fragments on the shell inner wall also shine. Due to no support inside the glow ball, its wall of the glow ball avoids puncturing. In this embodiment, chemiluminescent reagent (2-A) and chemiluminescent reagent (2-B) can be placed separately in two glass ampoules. When in this way, the release of the chemiluminescent reagents from breaking two glass ampoules can also obtain the glowing effect of the beauty of the liquid and glass fragments.

As shown in FIG. 3, FIG. 2, in another preferred implementation example of this invention, a pair of supporting bracket 4 is arranged in the ball shell 1, and the supporting bracket 4 is an activating device. The ball shell 1 is made of flexible and transparent material thermoplastic polyurethane TPU of 3 mm thickness, the ball shell 1 is 150 mm in diameter. Two breakable containers 3 set inside the ball shell 1 are glass ampoule bottles, of which the thickness is 0.5 mm, the length of 140 mm, the diameter is 12 mm, and two ends sealed. Wherein, one breakable container is sealed with 10 ml of chemiluminescence reagent 2-A composed of a light emitting agent containing CPPO and fluorescent agent. The other breakable container is sealed with 10 ml of chemiluminescence reagent 2-B composed of oxidation liquid containing hydrogen peroxide. The above two glass ampoules are embedded within the supporting bracket 4, which make them fixed well for ball shell 1, the supporting bracket 4 can be welded or bonded on the ball shell inner wall, and also can be manufactured integrated together with ball shell 1. When use, throw the ball to the ground or wall, break the glass ampoule to make the chemiluminescence reagent 2-A and chemiluminescence reagent 2-B release, the two reagents are mixed and generate a chemiluminescence reaction, and then release visible light.

On one hand, the supporting bracket 4 protects the glass ampoule in the product transportation, so that the product can be transported safely; on the other hand, when use, the product with the support bracket 4 is more easier to let users find the throwing direction when impact, because the glass ampoule is more easily broken in the horizontal stress, so the glow ball with a supporting bracket 4 is more easy to use for the users.

As shown in FIG. 4, in another preferred implementation example of this invention, the ball shell 1 is made of flexible and transparent material thermoplastic polyurethane TPU of 1.5 mm-thick, the ball shell 1 is 65 mm in diameter, and internal seals a 10 ml of chemiluminescence reagent 2-B, which is an Oxidation liquid containing hydrogen peroxide. The breakable containers 3 set in the inner sphere of the ball shell 1, with a wall thickness of 0.45 mm, the length of 50 mm, and diameter of 9 mm, are glass ampoule bottles of two ends sealed. Inside of the breakable container 3 sealed 1.6 g of chemiluminescence reagent 2-A, which is composed of a light emitting agent containing cppo and a fluorescent agent. The two ends of the glass ampoule are in contact with the inner surface of the ball shell 1 and are overhead by the ball shell 1. The activating device 4 is a supporting bracket to fix the glass ampoules. The activating device 4 comprises a tubular fixing device 4-1, which trapped or stuck in the middle part of the glass ampoule. Radial extension of tubular fixtures 4-1 are 4-2 rod, the 4-2 end extends to the inner wall of the contact position of the ball shell 1. When using, press the ball shell 1 with hands, the ball shell 1 will be sunken and squeeze rod 4-2 ,the rod 4-2 move so that the tubular fixing device 4-1 crushes the glass ampoules to make chemiluminescence reagent (2-A) release. The chemical 2-A and chemiluminescence 2-B in the ball shell 1 mix, generate a chemical reaction, and release visible light.

As shown in FIG. 5, in another preferred embodiment of the invention, the ball shell 1 is made of 1.5 mm-thick, flexible and transparent material, thermoplastic polyurethane (TPU), 65 mm in diameter. The two breakable containers 3 set in the ball shell 1 are glass ampoules with two ends sealed, 0.45 mm in thickness of its wall, 50 mm in length, and 9 mm in diameter. There are 1.5 ml chemiluminescent reagents (2-B) sealed in one of the two glass ampoules. The said chemiluminescent reagents (2-B) is oxidizing solution containing hydrogen peroxide. There are 1.6 g chemiluminescent reagents (2-A) sealed in the other glass ampoule. The said chemiluminescent reagents (2-A) is luminescence reagents component consisting of Bis Oxalate and fluorescent agent. The two ends of the glass ampoule are in contact with the inner surface of the ball shell 1 and are overhead by its cavity. The activating device 4 is also a bracket to fix glass ampoules. The said bracket comprises a fixing device 4-1, and a rod 4-2 connected with the fixing device 4-1. In this embodiment, the flat tubular fixing device 4-1 caught or stuck in the middle part of the two glass ampoules. The end of rod 4-2 extends to the contact position of the inner wall of the ball shell 1. A button 6 is located in the end of the rod. Button 6 with enlarged diameter make the user easier to operate, use and press, also reinforce the fixed effect of activating device 4 and ball shell 1. When using, press the ball shell 1 with hands. Then the ball shell 1 will be sunken and squeeze button 6 to drive rod 4-2 move so that the flat tubular fixing device 4-1 crushes two glass ampoules to have chemiluminescent reagents (2-A) and chemiluminescent reagents (2-B) released. The chemical 2-A and chemiluminescence 2-B in the ball shell 1 mix, generate a chemical reaction, and release visible light.

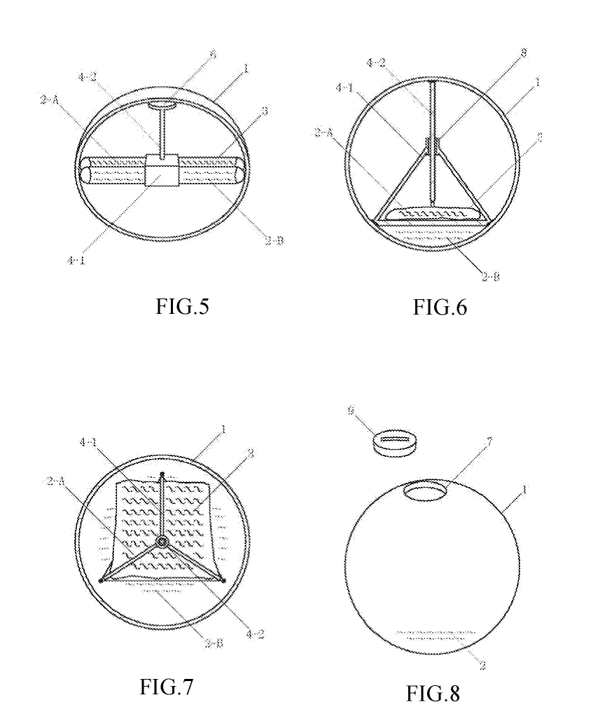

As shown in FIG. 6 and FIG. 7, in another preferred implementation example of this invention, the ball shell 1 is made of and transparent material thermoplastic polypropylene PP of 1.5 mm-thick, the ball shell 1 is 80 mm in diameter. Internal seals a 10 ml of chemiluminescence reagent 2-B, which is an Oxidation liquid containing hydrogen peroxide. The breakable containers 3 set in the inner sphere of the ball shell 1, is a thin film with 0.5 mm thick composite foil seal capsule, inside of the breakable containers 3 seals 16 ml of chemiluminescence reagent 2-A, which is a solution containing cppo, fluorescent agent and triethyl citrate solvent. The supporting bracket, the activating devices 4, is a group of hard plastics, which comprises a fixing device 4-1 and a rod 4-2 used to puncture. the tip of the rod 4-2 is arranged above the film sealing bag, and the other end is contacted with the inner surface of the ball shell 1. A guide hole 8 is arranged at the connecting point of the rod 4-2 and the fixing device 4-1, and the rod 4-2 passes through the guide hole 8. When using, press the rod 4-2 from its external of the ball shell 1 The rod 4-2 through the supporting bracket guide hole 8 slides down, the lower tip of the rod 4-2 pierces the breakable container 3 composed of film sealed capsule, and make chemiluminescence reagent (2-A) release. The chemical 2-A and chemiluminescence 2-B in the ball shell 1 mix, generate a chemical reaction, and release visible light.

As shown in FIG. 8, in another preferred embodiment of the invention, the ball shell 1 is made of 1.5 mm-thick, flexible and transparent silicone material, 80 mm in diameter. 50 ml of chemiluminescent reagents being chemiluminescent reaction are injected in the ball shell 1. The hollow ball shell 1 is provided with hole 7 and sealed with the sealing plug 9. The said glow ball has advantage in repeated use by opening the sealing plug 9 to pour off the chemiluminescent reagents that stopping glowing and refill new chemiluminescent reagents.

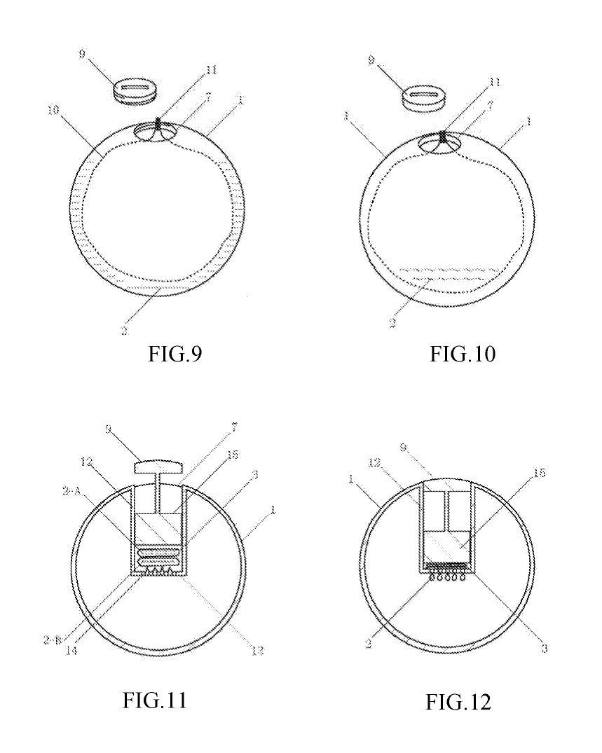

As shown in FIG. 9, in another preferred embodiment of the invention, the ball shell 1 is made of 1.5 mm-thick, flexible and transparent silicone material, 80 mm in diameter. 2 ml of chemiluminescent reagents being chemiluminescent reaction are injected in the ball shell 1. The hollow ball shell 1 is provided with hole 7. The inflatable capsule 10 is a sealed capsule made of 0.1 mm-thick polyethylene. When the inflatable capsule 10 is flatting, through the hole 7 pump air into the inflatable capsule 10 from the valve core 11 (one-way air inlet). When the inflatable capsule is inflated, the chemiluminescent reagents are extruded to the inner wall of the ball shell 1 and inflatable capsule 10. The ball can be played after its ball shell is sealed with the sealing plug 9. The glow ball has advantage in its glow that can be evenly distributed in the largest area of ball shell.

As shown in FIG. 10, in another preferred embodiment of the invention, the ball shell 1 is made of 1.5 mm-thick, flexible and transparent material-PVC, 80 mm in diameter. The hollow ball shell 1 is provided with the hole 7. The inflatable capsule 10 is made of 0.1 mm-thick polyethylene, within 20 ml of chemiluminescent reagents which are being chemiluminescent reaction. When the inflatable capsule 10 is flatting, put it from the hole 7, and pump air into the inflatable capsule 10 from the valve core 11 (one-way air inlet). When the inflatable capsule is inflated, seal the ball shell with the sealing plug 9 before play. The glow ball has advantage in having inflatable capsule 10 with replaceable chemiluminescent reagents, so that the said glow ball used repeatedly. The two kinds of chemiluminescent reagents, one kind of which can react with the other kind, can be set respectively in sealed breakable film pouches in advance, crush the breakable film pouches from outside of the inflatable capsule 10 to make the chemiluminescent reagents mix and glow. Due to the ball shell 1 in this solution can avoid contact with chemiluminescent reagents, the said ball shell 1 in this embodiment can also be made of PET, EVA or TPR.

As shown in FIG. 11 and FIG. 12, in another preferred implementation example of this invention, the ball shell 1 is made of 1.5 mm-thick, flexible and transparent material-PP, 80 mm in diameter. The hollow ball shell 1 has the hole 7 with diameter of 15 mm. A 40 mm long conduit 12 extending to the inner ball shell 1 is set in the hole 7 position, the blocking device 13 is set at the top of the conduit 12, and leaking 14 is set in the blocking device 13. The catheter 15 is set within the conduit 12, the sealing plug 9 is set at the top of the catheter 15, and the lower end of the piston 15 is equipped with two breakable container 3. The two breakable containers 3 respectively contain chemiluminescence reagent 2-A and 2-B, which can be glass ampoule bottle or film sealed capsule. When using, press the sealing plug 9, thereby push the catheter 15 and crush the breakable container to release chemiluminescence reagent. The said chemiluminescence reagent through the leaking 14 flow into the ball shell inside and mix to release light, at the same time, the sealing plug 9 seals the opening 7 to make it become a totally sealed ball.

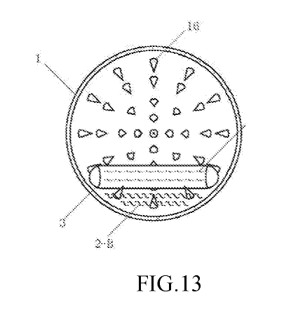

As shown in FIG. 13, in another preferred embodiment of the invention, the ball shell 1 is made of 2 mm-thick, flexible and transparent material, TPU, 100 mm in diameter. The breakable containers 3, which is set in the ball shell 1, is glass ampoules with two ends sealed, 0.5 mm in thickness of its wall, 85 mm in length, and 10 mm in diameter. 4 grams of chemiluminescent reagent (2-A) is sealed in the said glass ampoule. The said chemiluminescent reagent (2-A) is luminescence reagents component consisting of Bis-Oxalate and fluorescent agent. The chemiluminescent reagent (2-B) is 4 ml of oxidizing solution containing hydrogen peroxide. A plurality of conical protrusions 16 is provided on inner surface of ball shell 1. Activate the device till it glowing, the conical protrusions 16 of the inner surface can diffuse glowing liquid better to slow down the downward flow and accumulation of the glowing liquid, and then to make its glow more evenly. For the same reason, the inner surface of shell ball 1 may be polyhedral or with many pits or grooves or/and protrusive ribs to make glowing liquid or solid distribute more evenly.

A plurality of conical protrusion 16 on the inner wall of the ball shell 1, which can greatly reduce the possibility of the TPU shell puncture and leakage when the glass is broken and after the ball is played. It is because the protrusive parts hold the broken glass fragments, and the sharp cutting edge can not form enough impact force to pierce the ball wall. In a ball shell 1 TPU ball with a diameter of 65 mm and a wall thickness of 2 mm, two glass ampoule with a diameter of 10 mm, a wall thickness of 0.35 mm, and the length of 60 mm, is placed. Each inside of the ampoule is equipped with chemiluminescence reagent 2 mm, and the air is filled with 2 kg/cm̂2 in the ball. In another contrast test, ball shell is 65 mm in diameter, 1.8 mm of wall thickness. The inner wall is covered with a number of protrusive cylinder with a diameter of 1.2 mm and a height of 1.2 mm, and cylindrical interval is 1.2 mm. The ball inside has the said same glass ampoule and is filled with air. The above two ball each has 500 pieces. After breaking up internal ampoule bottle, and from the height of 4 meters throw into the ground 100 times, then check the leakage from puncture of the ball. Four of the ball without internal protrusions were detected with tiny breaches, while the balls with internal protrusions are not found leakage.

Ball shell 1 can be spherical or ellipsoidal or olive shape or polyhedron. Disperse particles can also be placed into the inner empty cavity of ball shell 1 to make the light liquid or solid distribution more evenly or interesting. The particles can be paper, plastic film, or small plastic particles etc. Complicated shape or internal dispersed particles can make the glowing liquid or solid more evenly distributed or flow more interesting. The inner wall of the ball shell with protrusions or polyhedral or a plurality of pits or grooves or/and a protrusive rib and is placed with dispersed particles, such as scraps of paper, plastic film, or small plastic particles . . . Not only do give people a sense of uniform dispersion effect, also a certain visual shielding effect to the broken containers and broken pieces to reduce users' discomfort perception of, for example, the glass fragments.

In the end illustration of the instant invention, it is understood that the above application example is only used to illustrate the technical scheme of this invention but not interpreted as limiting. Although the instant invention has been described in specific embodiments accompanying better drawings, the normal technical workers can understand it, and can make modification or make equal substitutions of the technical schemes without departing from the spirit and scope of this invention, and all such are defined by the claims of this invention.

1. A type of glow ball comprises a ball shell made of flexible and transparent material and has an empty cavity inside the shell, wherein the said empty cavity contains at least two chemiluminescent reagents, the chemiluminescent reagents being solid or liquid or a solid-liquid mixture, wherein the at least two chemiluminescent reagents being encapsulated respectively and configured to generate chemiluminescence reaction when they are combined, at least one chemiluminescent reagent sealed inside one or more breakable containers.

2. The glow ball according to claim 1, wherein the breakable container is a sealed glass container or film capsule.

3. The glow ball according to claim 1, wherein the empty cavity is set with an activating device of the breakable containers.

4. The glow ball according to claim 3, wherein the activating device is a bracket capable of supporting and/or fixing the breakable container.

5. The said glow ball according to claim 4, wherein the bracket includes the fixing device and a rod connects with it, one end of the rod pointing to the breakable container, the other end pointing to the ball shell inner wall and near or in contact with the ball shell inner wall, the fixing device stuck to the breakable container.

6. The glow ball according to claim 1, wherein the ball shell is set with a hole and a sealing plug matched with the hole, tube placed from the hole to the empty cavity of the ball shell, a blocking device set at one end of the tube in the inner empty cavity of the said ball shell, wherein leaks are set on the blocking device, rod set in one side of the sealing plug in the ball shell, an end of the rod provided with a piston which is matched with the inner wall of the tube for movement, the said breakable containers between the piston and the blocking device.

7. A type of glow ball, comprises a ball shell made of transparent material and empty cavities placed in the said ball shell, wherein the said ball shell is set within a hole, a sealing plug is equipped on the hole, and the said empty cavity contains chemiluminescent reagent.

8. The glow ball according to claim 7, wherein the said ball shell is set with a sealed inflatable capsule, the said chemiluminescent reagents are sealed inside the said inflatable capsule or the areas between the said inflatable capsule and the said ball shell inner wall.

9. The glow ball according to claim 7, wherein the said ball shell contains the hole, the sealing plug is set on the said hole, the sealed inflatable capsule is equipped inside the said ball shell, the chemiluminescent reagents are placed inside the said inflatable capsule, the said chemiluminescent reagents are two kinds of reagent sealed separately and can generate chemiluminescent reaction when they are combined, and at least one kind chemiluminescent reagent is contained in one or more breakable film capsules.

10. The glow ball according to claim 9, wherein an appearance of the said ball shell is spheroidal or elliptical or oval or polyhedral, meanwhile its inner surface is polyhedral or with many pits or/and protrusions, or with grooves or/and protrusive ribs.
